(19) United States
(12) Patent Application Publication
(10) Pub. No.: US 2026/0254118 A1
(43) Pub. Date: Aug. 27, 2026

(54) MULTI-BAND ARCHITECTURE

(71) Applicant: SKYWORKS SOLUTIONS, INC., Irvine, CA (US)

(72) Inventors: Fred Jay Anderson, Port Charlotte, FL (US); Grant Darcy Poulin, Carp (CA)

(21) Appl. No.: 19/462,533

(22) Filed: Jan. 28, 2026

Related U.S. Application Data
(60) Provisional application No. 63/751,052, filed on Jan. 29, 2025.

(51) Int. Cl. H01Q 5/342; H01Q 3/24; H01Q 5/20

(52) U.S. Cl. CPC H01Q 5/342; H01Q 3/24; H01Q 5/20

(57) ABSTRACT

A system, radio architecture, and/or wireless device may include a transceiver and/or a first front-end module (FEM) directly coupled to the transceiver and providing coverage of multiple bands of a wireless network. The device may include a first switch directly coupled to the first front-end module. The device may include a first filter directly coupled to the first switch. The device may include a second filter directly coupled to the first switch. The device may include a second switch directly coupled to the first filter and the second filter. The device may include a first antenna coupled to the second switch.

### CROSS-REFERENCE TO RELATED APPLICATION(S)

This application claims priority to U.S. Provisional Application No. 63/751,052 filed Jan. 29, 2025, entitled MULTI-BAND ARCHITECTURE, the disclosure of which is hereby expressly incorporated by reference herein in its respective entirety.

### BACKGROUND

### Field

The present disclosure relates to circuits, devices and methods for radio architectures.

### Description of the Related Art

Frequency band configurability of radios is a point of emphasis in designing multi-radio Wi-Fi access point (AP) architectures, particularly for enterprise markets. APs may be designed to offer coverage in the 2.4 GHz Industrial, Scientific, Medical (ISM) bands and/or 5-7 GHz Unlicensed National Information Infrastructure (UNII) bands. There are up to nine different bands of operation, depending on regulatory domain. The AP designer may offer simultaneous operating modes in any or all of these bands. Radio frequency (RF) coexistence of these radios may be challenging due to the Carrier Sense Multiple Access (CSMA) protocols and/or close inter-band frequency spacing which dictate stringent RF filter requirements for stopband transition. In addition, practical limitations of limited broadband power amplifier (PA) and RF filter performance can present challenges.

### SUMMARY

In accordance with a number of implementations, the present disclosure relates to a system including a transceiver, a first front-end module (FEM) directly coupled to the transceiver and providing coverage of multiple bands of a wireless network, a first switch directly coupled to the first front-end module, a first filter directly coupled to the first switch, a second filter directly coupled to the first switch, a second switch directly coupled to the first filter and the second filter, and a first antenna coupled to the second switch.

In some examples, the system further includes a host device directly coupled to the transceiver. The first FEM may provide coverage of a first band and a second band, the system further including a second FEM coupled to the host device and providing coverage of the first band.

The system may further include a third FEM coupled to the host device and providing coverage of the second band. In some examples, the first FEM provides partial coverage of the first band and the second FEM provides full coverage of the first band.

In some examples, the system further includes a diplexer coupled between the second switch and the first antenna. The first FEM may provide coverage of a first band and a second band, the system further including a second FEM coupled to the diplexer and providing coverage of a third band.

The system may further include a third filter coupled between the second FEM and the diplexer.

Some implementations of the present disclosure relate to a wireless device including a first transceiver, an antenna, a diplexer coupled between the first transceiver and the antenna, a first front-end module (FEM) coupled between the first transceiver and the diplexer and providing coverage of a first band and a second band of a wireless network, and a second FEM coupled to the diplexer and providing coverage of a third band of the wireless network.

The wireless device may further include a host device directly coupled to the first transceiver. In some examples, the wireless device further includes a second transceiver coupled between the second FEM and the host device.

In some examples, the wireless device further includes a first filter coupled between the first FEM and the diplexer and a second filter coupled between the first FEM and the diplexer. The wireless device may further include a first switch directly coupled to the first filter, the second filter, and the diplexer.

The wireless device may further include a third filter coupled between the second FEM and the diplexer.

In accordance with some implementations, the present disclosure relates to a wireless device including a host device, a first transceiver coupled to the host device, a second transceiver coupled to the host device, a first antenna, a second antenna, a first front-end module (FEM) coupled between the first transceiver and the first antenna and providing at least partial coverage of a first band and a second band of a wireless network, and a second FEM coupled between the second transceiver and the second antenna and providing at least partial coverage of the first band of the wireless network.

In some examples, the wireless device further includes a first filter and a second filter coupled between the first FEM and the first antenna. The wireless device further includes a first switch directly coupled to the first filter and the second filter.

The wireless device further includes a third FEM coupled to the host device, the third FEM providing at least partial coverage of the second band of the wireless network. In some examples, the third FEM provides full coverage of the second band.

In some examples, the second fem provides full coverage of the first band.

For purposes of summarizing the disclosure, certain aspects, advantages, and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a schematic of an example radio-frequency (RF) front end module (FEM) connected to an antenna.

FIG. 2 illustrates the access point configured with the 6 GHz antenna′ front end circuitry in a transmit path (Tx) configuration and with the 5 GHz antenna front end circuitry in a receive path (Rx) configuration.

FIG. 3 illustrates the access point configured with the 5 GHz antenna front end circuitry in a transmit configuration and with the 6 GHz antenna′ front end circuitry in a receive path configuration.

FIG. 4 illustrates a pair of front-end modules that have their bandpass filters positioned on the small signal side of the amplifiers.

FIG. 5 illustrates an example architecture for one or more devices (e.g., wireless devices and/or APs) in accordance with one or more examples.

FIG. 6 illustrates another example architecture for one or more devices (e.g., wireless devices and/or APs) in accordance with one or more examples.

FIG. 7 illustrates another example architecture for one or more devices (e.g., wireless devices and/or APs) in accordance with one or more examples.

FIG. 8 illustrates another example architecture for one or more devices (e.g., wireless devices and/or APs) in accordance with one or more examples.

FIG. 9 provides a graph illustrating filter response for multiple bands in accordance with one or more examples.

FIG. 10 provides a table illustrating band coverage across various architectures and/or devices (e.g., SoC devices) for various configurations in accordance with one or more examples.

FIG. 11 provides a table illustrating band coverage across various architectures and/or devices (e.g., SoC devices) for various configurations in accordance with one or more examples.

FIG. 12 is a schematic diagram of a wireless device that can incorporate aspects of radio architectures disclosed herein.

### DESCRIPTION

The headings provided herein, if any, are for convenience only and do not necessarily affect the scope or meaning of the claimed invention.

Frequency band configurability of radios is a point of emphasis in designing multi-radio Wi-Fi access point (AP) architectures, particularly for enterprise markets. APs may be designed to offer coverage in the 2.4 GHz Industrial, Scientific, Medical (ISM) bands and/or 5-7 GHz Unlicensed National Information Infrastructure (UNII) bands. There are up to nine different bands of operation, depending on regulatory domain. The AP designer may offer simultaneous operating modes in any or all of these bands. Radio frequency (RF) coexistence of these radios may be challenging due to the Carrier Sense Multiple Access (CSMA) protocols and/or close inter-band frequency spacing which dictate stringent RF filter requirements for stopband transition. In addition, practical limitations of limited broadband power amplifier (PA) and RF filter performance can present challenges.

A desirable architecture may provide increased configurability and/or stringent technical requirements by providing the following: 2.4 GHz coverage; 5 GHz coverage with dual simultaneous radio configurability; 6 GHz coverage with dual simultaneous radio configurability; inclusion of UNII4 band channels without coexistence limitations to adjacent UNII5 channels; realization of the preceding capabilities with three or four simultaneous radio chains. This desirable architecture may provide maximum world-wide coverage with, for example, a single product hardware and/or increased configurability for wireless networks.

Adding UNII4 coverage to the top edge of the UNII2c-UNII3 band can be achieved at the expense of UNII5 channels due to a narrow (e.g., 50 MHz) transition band between UNII3 and UNII4. In some cases, a combination of filter (e.g., narrow band and aggressive rolloff) may be switched in and out depending on the operating channels selected. High performance dual 5 and dual 6 GHz operation may be cost-penalized by the lack of front-end modules (FEMs) with sufficient operational bandwidth to be used in either 5 or 6 dual band scenarios. Consequently, solving the problem with a duality of (2) 5 GHz FEMs and (2) 6 GHz FEMs can be cost prohibitive.

Described herein are example radio architectures offering UNII1-UNII8 coverage with (1) configurability for dual radios in either the 5 GHz or 6 GHz band segments, (2) coverage of the UNII4 band without compromises to adjacent bands, and/or (3) a simple, fundamental architecture including high-performance parts with minimal size.

In some examples, an architecture can leverage high-performance wide-band FEMs and/or “World Band” bulk acoustic wave (BAW) filters covering all UNII bands (including UNII4) with effective stopband performance. Wide-band FEMs can allow one radio chain to cover either a 5 GHz range or a 6 GHz range. “World band” BAW filters can enable complete and/or no-compromise coexistence between radios operating in the UNII4 and UNII5 bands. Such an architecture can enable Wi-Fi devices (APs in particular) equipped with three high-band radios to efficiently provide (2) 5 GHz+(1) 6 GHz operation, (1)5 GHz+(2) 6 GHz operation, or both with UNII4 coverage. BAW filters in the examples herein may be configured to operate at edges of bands and/or to provide little attenuation at edges and/or increased attenuation in adjacent bands to avoid interference.

Some architectures may involve FEMs for 5 GHz and 6 GHz band(s) to achieve effective performance in medium-to high-power applications (e.g., typical of enterprise-class APs). Some examples herein may advantageously utilize Digital Pre-Distortion (DPD) enabled FEMs, which may provide coverage of multiple bands (e.g., UNII2C-UNII8). For example, a wideband FEM may be used to reduce the number of single band FEMs in the following radio configurations: (2) 5 GHz or (1) 5 GHz+(1) 6 GHz; (2) 5 GHz+(1) 6 GHz; and/or (1) 5 GHz+(2) 6 GHz. In some examples, one radio chain may advantageously cover either 5 GHz or 6 GHz without requiring a duality of single band FEMs. Some examples may include a single 2.4 GHz radio chain, which may be diplexed at an antenna to a 5 GHz chain.

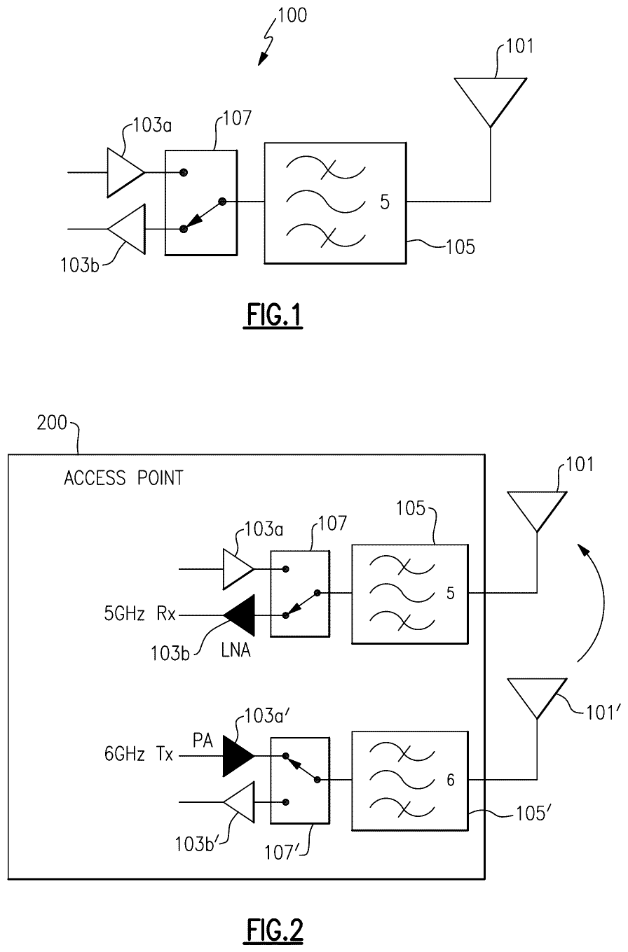

FIG. 1 illustrates a schematic of an example radio-frequency (RF) front end module (FEM) 100 connected to an antenna 101. As illustrated in FIG. 1, the front-end module 100 comprises amplifiers 103a, 103b, bandpass filter 105, and/or switch 107. However, it will be appreciated that this is a simplified representation of the front-end module 100, and that in practice other (not illustrated) components may be incorporated into front-end module 100, including between illustrated components.

When incorporated into an electronic device, the front-end module 100 typically will be connected to a transceiver as part of a transmit path, a receive path, or both. The front-end module 100 illustrated can be incorporated as part of both the transmit path and the receive path by virtue of amplifiers 103a, 103b and switch 107. Amplifiers 103a, 103b include a power amplifier 103a for use in the transmit path and a low noise amplifier 103b for use in the receive path, whilst switch 107 allows either to be connected into a signal path incorporating the bandpass filter 105 and the antenna 101. In FIG. 1, the front-end module is shown configured in a receive path state, with the low noise amplifier 103b shown connected into the signal path by switch 107.

The bandpass filter 105, in this case a 5 GHz bandpass filter, only passes signals within its passband. That is, signals that are outside the passband of the bandpass filter 105 (out of band or OOB signals) are attenuated, typically by 50-60 dB, such that they are filtered out and are not passed down the signal path. One situation in which this is useful is when two or more antennae are used in proximity to each other, either on the same device or on another nearby device, to filter out unwanted incoming signals in a different band and to prevent transmitted signals from one antenna blocking the nearby antenna.

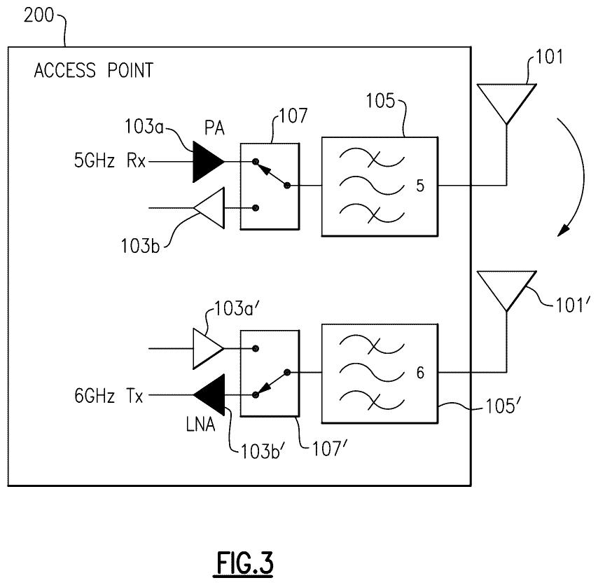

FIGS. 2 and 3 are schematic illustrations of an access point 200 having two antennae 101, 101′. Each antenna 101, 101′ has separate front end circuitry, similar to the front-end module 100 shown in FIG. 1. However, the bandpass filters 105, 105′ connected to each antenna 101, 101′ have different passbands: bandpass filter 105 is a 5 GHz bandpass filter whilst bandpass filter 105′ is a 6 GHz bandpass filter. As the front-end circuitry for each antenna 101, 101′ comprises a switch 107, 107′ that can switch between a power amplifier 103 a, 103a′ and a low noise amplifier 103b, 103b′, each antenna can transmit and receive.

FIG. 2 illustrates the access point 200 configured with the 6 GHz antenna 101′ front end circuitry in a transmit path (Tx) configuration and with the 5 GHz antenna 101 front end circuitry in a receive path (Rx) configuration. That is, bandpass filter 105′ is connected, by switch 107′, to power amplifier 103a′ and bandpass filter 105 is connected, by switch 107, to low noise amplifier 103b. In this configuration, the 6 GHz bandpass filter 105′ rejects out of band noise (including noise that is within the 5 GHz passband of bandpass filter 105) that would otherwise be received by antenna 101 and degrade the noise floor and cause desensitization of the low noise amplifier 103b in the 5 GHz signal path. FIG. 3, on the other hand, illustrates the access point 200 configured with the 5 GHz antenna 101 front end circuitry in a transmit configuration and with the 6 GHz antenna 101′ front end circuitry in a receive path configuration. That is, bandpass filter 105′ is connected, by switch 107′, to low noise amplifier 103b′ and bandpass filter 105 is connected, by switch 107, to power amplifier 103a. In this configuration, the 6 GHz bandpass filter 105′ rejects 5 GHz signal leakage that would otherwise saturate low noise amplifier 103b′ resulting in desensitization. It will be appreciated that the 5 GHz bandpass filter 105 also provides these benefits with respect to its associated circuitry.

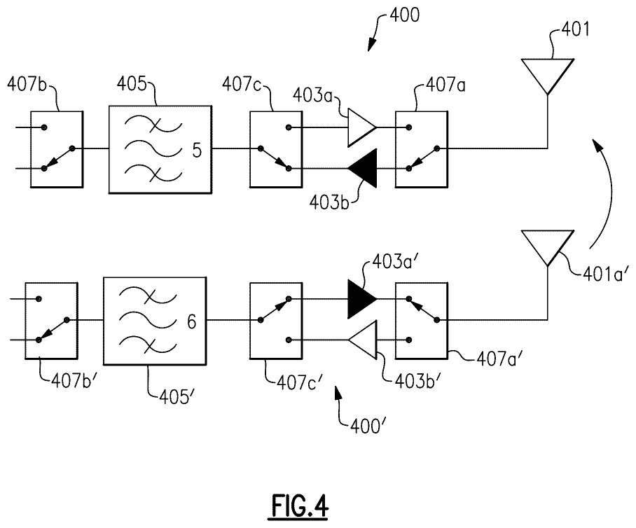

FIG. 4 illustrates a pair of front-end modules 400, 400′ that have their bandpass filters 405, 405′ positioned on the small signal side of the amplifiers 403a, 403a′. That is, the amplifiers 403a, 403b, 403a′, 403b′ are positioned between the bandpass filters 405, 405′ and the antenna ports which connect the front-end modules 400, 400′ to their respective antennae 401, 401′.

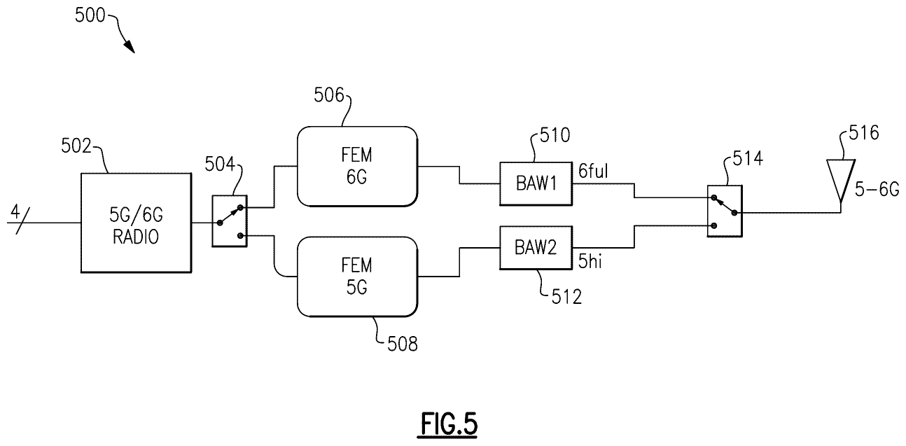

FIG. 5 illustrates an example architecture 500 for one or more devices (e.g., wireless devices and/or APs) in accordance with one or more examples. The architecture 500 may comprise a transceiver 502 (e.g., radio transceiver), a first switch 504, a first FEM 506 (e.g., 6G FEM), a second FEM 508 (e.g., 5G FEM), a first filter 510 (e.g., BAW filter) coupled to the first FEM 506, a second filter 512 (e.g., BAW filter) coupled to the second FEM 508, a second switch 514 coupled to the first filter 510 and/or second filter 512, and/or an antenna 516 coupled to the second switch 514. The first switch 504 may be coupled between the transceiver 502 and the first FEM 506 and/or between the transceiver and the second FEM 508. While separate FEMs are used in FIG. 5 for the 5G and 6G bands, a single FEM may advantageously be used for multiple bands to reduce cost and/or size of the architecture 500, as described herein.

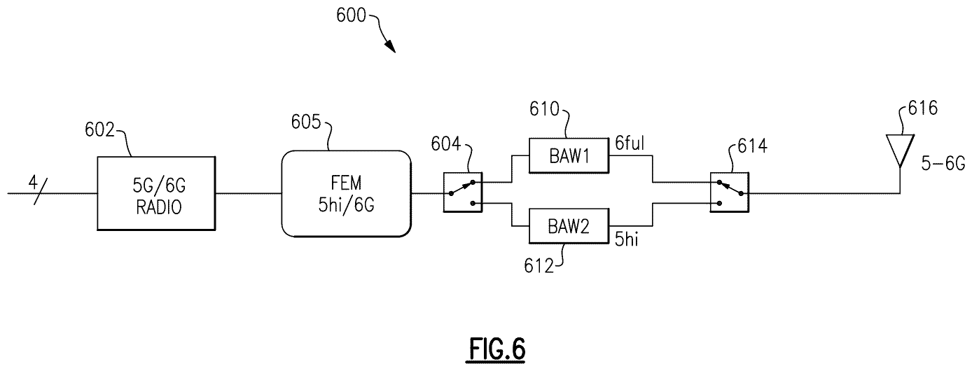

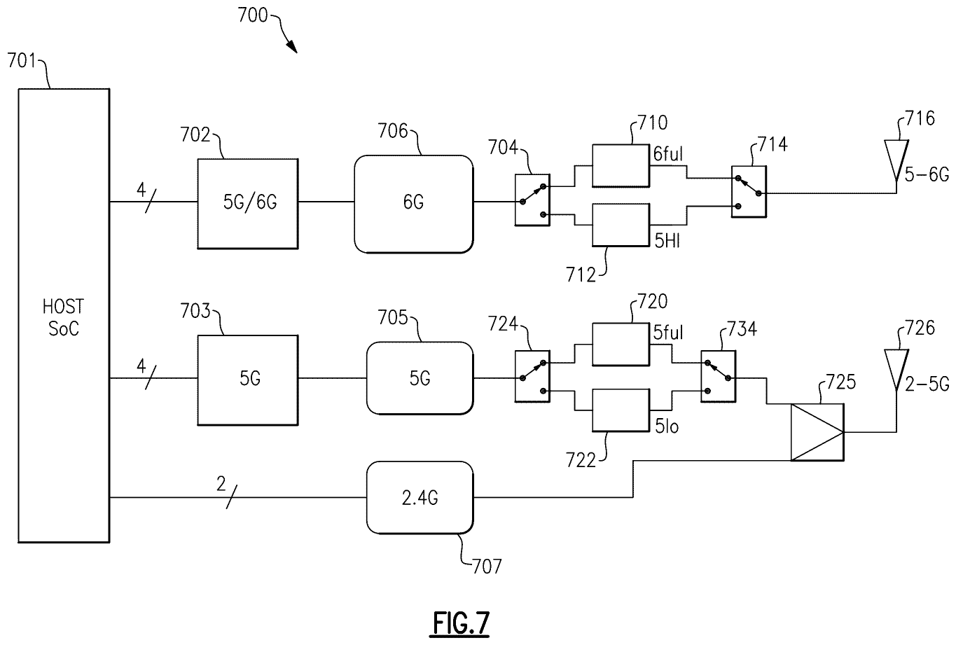

FIG. 6 illustrates another example architecture 600 for one or more devices (e.g., wireless devices and/or APs) in accordance with one or more examples. The architecture 600 may comprise a transceiver 602 (e.g., radio transceiver), an FEM 605 (e.g., covering at least a high and/or upper portion of the 5G band and/or at least a portion or the entire 6G band), a first switch 604, a first filter 610 (e.g., BAW filter associated with and/or covering at least a portion and/or the entire 6G band) coupled to the first switch 604, a second filter 612 (e.g., BAW filter associated with and/or covering at least a high and/or upper portion of the 5G band) coupled to the first switch 604, a second switch 614 coupled to the first filter 610 and/or second filter 612, and/or an antenna 616 coupled to the second switch 614. The first switch 604 may be coupled between the first filter 610 and the FEM 605 and/or between the second filter 612 and the FEM 605. Using a single FEM to cover at least portions of multiple bands may advantageously reduce size and/or cost of the architecture 600. In some examples, the FEM 605 may be used for multiple output (MIMO) streams instead of two or more FEMs per MIMO stream. Similarly, in a four-stream architecture, the total number of FEMs required may be reduced from eight to four. The architecture 600 may comprise four or more parallel systems as illustrated in FIG. 6.

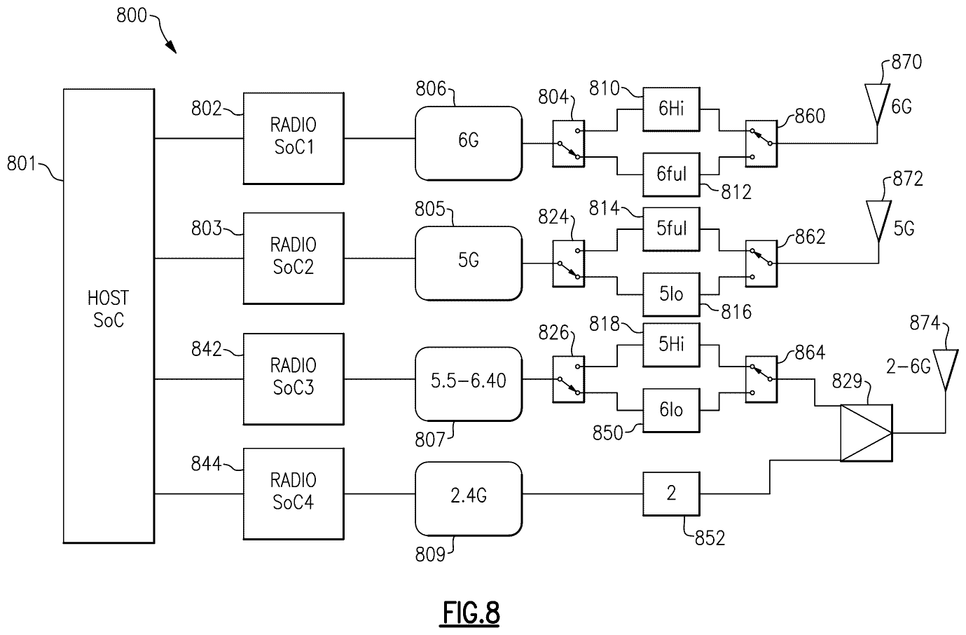

FIG. 7 illustrates another example architecture 700 for one or more devices (e.g., wireless devices and/or APs) in accordance with one or more examples. The architecture 700 may comprise a host 701 (e.g., system on a chip (SoC)), a first transceiver 702 (e.g., radio transceiver) coupled to the host 701, a second transceiver 703 coupled to the host 701, a first FEM 706 (e.g., covering at least a high and/or upper portion of the 5G band, at least a portion or the entire 6G band, and/or at least a lower portion of a 7G band) directly coupled to the first transceiver 702, a second FEM 705 (e.g., covering at least a lower portion of a 5G band) directly coupled to the second transceiver 703, a third FEM 707 directly coupled to the host 701, a first switch 704 directly coupled to the first FEM 706, a second switch 724 directly coupled to the second FEM 705, a first filter 710 (e.g., BAW filter associated with and/or covering at least a portion and/or the entire 6G band) directly coupled to the first switch 704, a second filter 712 (e.g., BAW filter associated with and/or covering at least a high and/or upper portion of the 5G band) directly coupled to the first switch 704, a third filter 720 (e.g., BAW filter associated with and/or covering at least a portion and/or the entire 5G band) directly coupled to the second switch 724, a fourth filter 722 (e.g., BAW filter associated with and/or covering at least a low and/or lower portion of the 5G band) directly coupled to the second switch 724, a third switch 714 coupled to the first filter 710 and/or second filter 712, a fourth switch 734 directly coupled to the third filter 720 and/or fourth filter 722, a first antenna 716 directly coupled to the third switch 714, a second antenna 726 coupled to the fourth switch 734, and/or a diplexer 725 coupled directly coupled to the second antenna 726, the fourth switch 734, and/or the third FEM 707. The architecture 700 may include two FEMs (e.g., the first FEM 706 and/or second FEM 705) covering the 5G band and/or only the second FEM 705 may cover the 5G band while the first FEM 706 covers the 6G and/or 7G bands. The third FEM 707 may cover and/or may be associated with the 2.4G and/or other band.

While only one diplexer 725 is shown in FIG. 7, additional diplexers and/or no diplexers may be used. For example, an additional diplexer may be coupled to the first antenna 716. In some examples, an architecture may include one or more diplexers to advantageously limit a number of FEMs. However, no diplexers may be used in some examples.

FIG. 8 illustrates another example architecture 800 for one or more devices (e.g., wireless devices and/or APs) in accordance with one or more examples. The architecture 800 may comprise a host 801 (e.g., system on a chip (SoC)), a first transceiver 802 (e.g., radio transceiver) coupled to the host 801, a second transceiver 803 coupled to the host 801, a third transceiver 842 coupled to the host 801, and/or a fourth transceiver 844 coupled to the host 801. One or more of the transceivers may comprise SoC devices. Any of the couplings shown in FIG. 8 and other figures herein may be direct or indirect couplings.

The architecture 800 may further comprise a first FEM 806 (e.g., covering at least a portion of a 6G band) directly coupled to the first transceiver 802, a second FEM 805 (e.g., covering at least a portion of a 5G band) directly coupled to the second transceiver 803, a third FEM 807 (e.g., covering at least an upper and/or high portion of the 5G band and/or a lower portion of the 6G band) directly coupled to the third transceiver 842, and/or a fourth FEM 809 (e.g., covering at least a portion of a lower (e.g., 2.4G) band) directly coupled to the fourth transceiver 844. The architecture 800 may include other numbers of FEMs. In some examples, the FEMs may cover different bands and/or portions of bands.

In some examples, the architecture 800 may comprise a first switch 804 directly coupled to the first FEM 806, a second switch 824 directly coupled to the second FEM 805, and/or a third switch 826 directly coupled to the third FEM 807. The first switch 804 may additionally be directly coupled to a first filter 810 (e.g., BAW filter associated with and/or covering at least a portion and/or the entire 6G band) and/or a second filter 812 (e.g., BAW filter associated with and/or covering the full 6G band). The second switch 824 may be directly coupled to a third filter 814 (e.g., BAW filter associated with and/or covering the full 5G band) and/or a fourth filter 816 (e.g., BAW filter associated with and/or covering at least a low and/or lower portion of the 5G band). The third switch 826 may be directly coupled to a fifth filter 818 (e.g., BAW filter associated with and/or covering at least a high and/or higher portion of the 5G band) and/or a sixth filter 850 (e.g., BAW filter associated with and/or covering at least a low and/or lower portion of the 6G band). The fourth FEM 809 may be directly coupled to a seventh filter 852 (e.g., BAW filter associated with and/or covering a full 2G band).

The architecture 800 may further comprise a fourth switch 860 directly coupled between the first filter 810, the second filter 812, and a first antenna 870. In some examples, the architecture 800 may comprise a fifth switch 862 directly coupled between the third filter 814, the fourth filter 816, and a second antenna 872. A sixth switch 864 may be directly coupled between the fifth filter 818, the sixth filter 850, and a diplexer 829. The diplexer 829 may be directly coupled between the sixth switch 864, the seventh filter 852, and a third antenna 874. The first antenna 870 may be configured to transmit signals within the 6G band, the second antenna 872 may be configured to transmit signals within the 5G band, and/or the third antenna may be configured to transmit signals within a range of the 2-6G bands.

The various architectures described herein may utilize BAW filters configured to provide relatively steep stopband performance for narrow transition bands (e.g., between UNII4 and UNII5 (50 MHz)). Surface Acoustic Wave (SAW) filter and/or other solutions for UNII4 coverage may not be capable of achieving such relatively steep stopband with an entire passband performance for either the 5 GHz band or 6 GHz Band filter. Consequently, a combination of narrower sub-band filters may be useful to provide switching and/or a multiplicity of filters depending on which segment of the 5 or 6 GHz band is tuned. BAW filters described herein may enable UNII4 performance within the ranges UNII1-UNII4, UNII2C-UNII4, UNII5-8, and/or UNII5. Architectures described herein may also allow for reduced roll-off on edge channels in the UNII2-UNII2C transition band. Also, in the UNII6 band, normally fully consumed as a transition band between UNII5 and UNII7, the architectures described herein may allow for additional channels (e.g., 20 MHz channel, 113, 40 MHz channel, 115, or 80 MHz channel 119) to be available.

Some filters (including BAW filters) may experience insertion loss and/or compromised power handling at upper and/or lower passbands and/or near transitions between bands. Transitions of one or more bands may be too sharp to provide adequate attenuation in alternate bands. In some cases, bands may experience aggressive attenuation above passband.

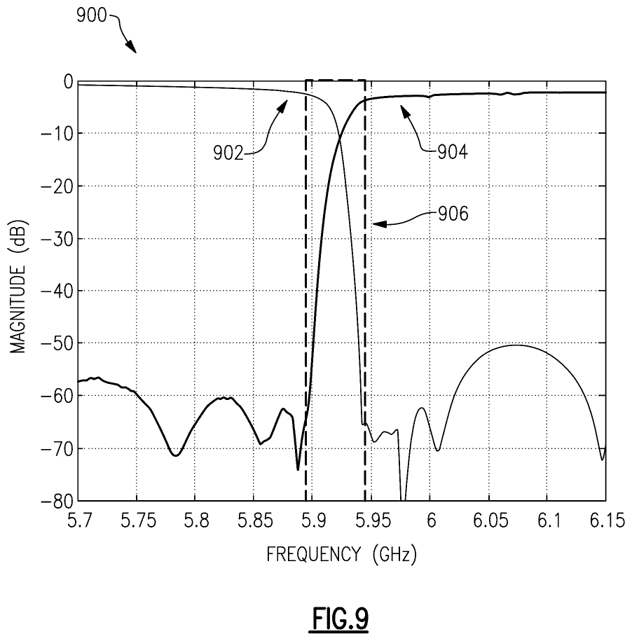

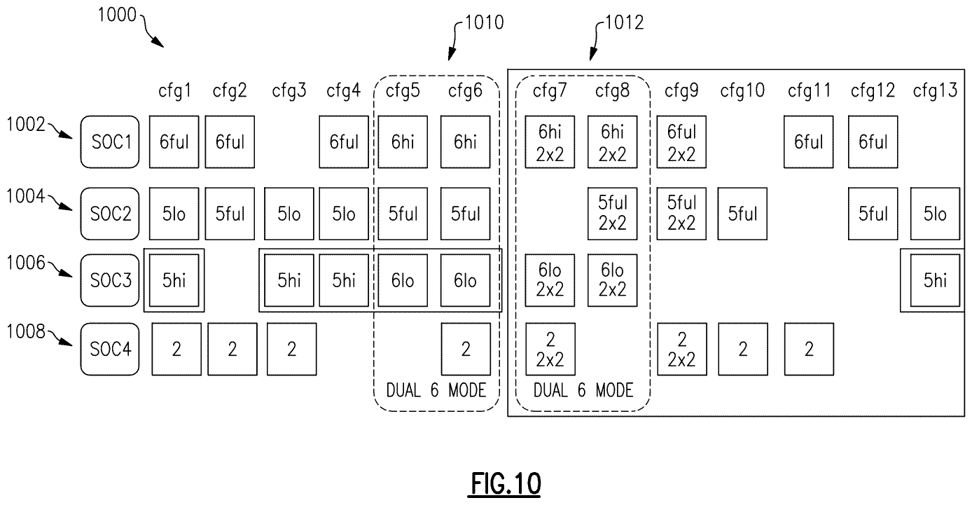

FIG. 9 provides a graph 900 illustrating filter response for multiple bands in accordance with one or more examples. A first range 902 (e.g., UNII-1 to UNII-4) and/or a second range 904 (UNII 5-8) may be passed through one or more BAW filters configured to provide effective filter stopband attenuation within a narrow transition band 906. The transition band 906 may represent a range between the UNII-4 and UNII-5 bands (e.g., from 5895 to 5975 MHz).

FIG. 10 provides a table 1000 illustrating band coverage across various architectures and/or devices (e.g., SoC devices) for various configurations in accordance with one or more examples. Each of a first device 1002 (e.g., host and/or SoC device), second device 1004, third device 1006, and/or fourth device 1008 may comprise one or more FEMs configured to provide coverage of one or more bands of a wireless network. Coverage provided by each device may be adjusted based on use and/or placement of filters, switches, FEMs, and/or other devices within an architecture. In a 2×2 architecture, each band may include two channels.

In some examples, multiple devices may provide coverage over a band (e.g., over a 6G band). For example, in a first dual mode 1010 and/or second dual mode 1012, the first device 1002 may provide coverage of an upper area of the 6G band while the third device 1006 may provide coverage of a lower area of the 6G band. In some cases, a fourth FEM may not be required (e.g., at cfg5 of FIG. 10). The first device 1002 and/or third device 1106 may include a single FEM or multiple FEMs.

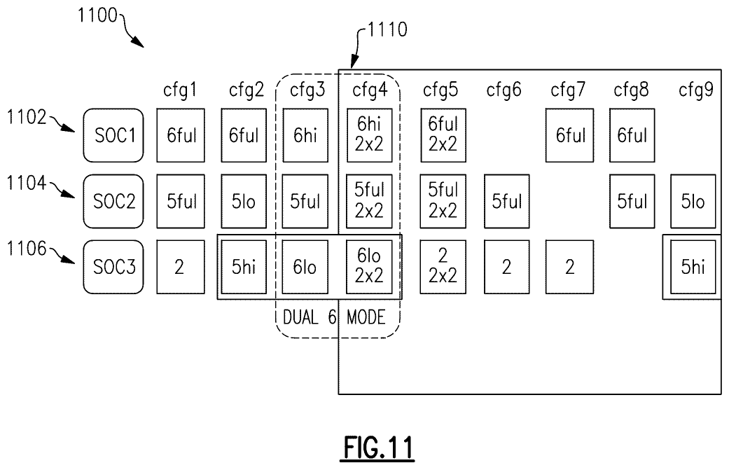

FIG. 11 provides a table 1100 illustrating band coverage across various architectures and/or devices (e.g., SoC devices) for various configurations in accordance with one or more examples. Each of a first device 1102 (e.g., host and/or SoC device), second device 1104, and/or third device 1106 may comprise one or more FEMs configured to provide coverage of one or more bands of a wireless network. Coverage provided by each device may be adjusted based on use and/or placement of filters, switches, FEMs, and/or other devices within an architecture. In a first dual mode 1110, the first device 1102 may provide coverage of an upper area of the 6G band while the third device 1106 may provide coverage of a lower area of the 6G band.

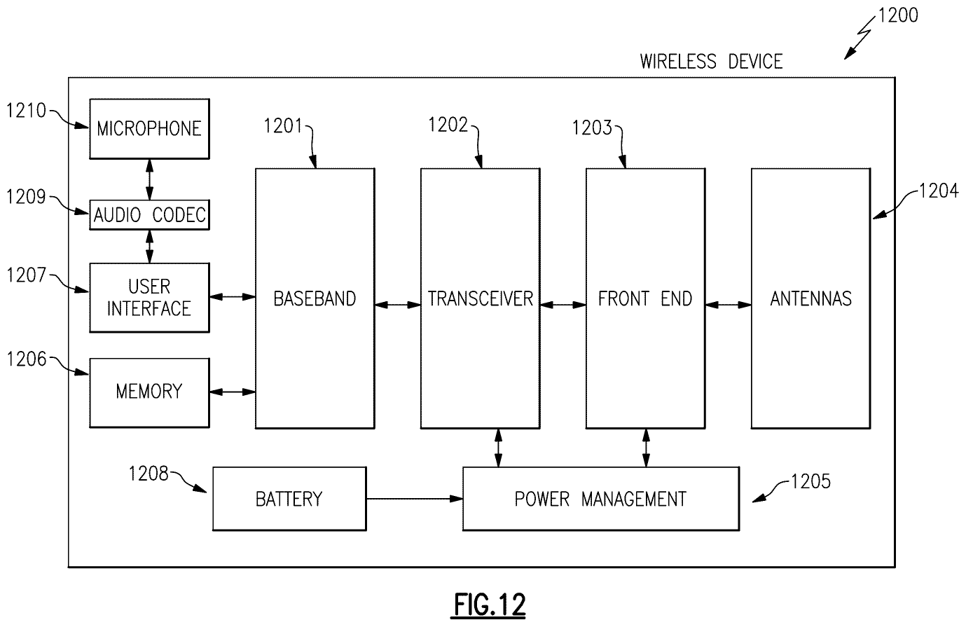

FIG. 12 is a schematic diagram of a wireless device 1200 that can incorporate aspects of radio architectures disclosed herein. The wireless device 1200 can be, for example but not limited to, a wireless access point, such as a router, or a portable telecommunication device, such as a mobile cellular-type telephone. The wireless device 1200 can include a microphone arrangement 1210, and may include one or more of a baseband system 1201, a transceiver 1202, a front-end system 1203, one or more antennae 1204, a power management system 1205, a memory 1206, a user interface 1207, a battery 1208, and audio codec 1209. The microphone arrangement 1210 may supply signals to the audio codec 1209 which may encode analog audio as digital signals or decode digital signals to analog. The audio codec 1209 may transmit the signals to a user interface 1207. The user interface 1207 transmits signals to the baseband system 1201. The transceiver 1202 generates RF signals for transmission and processes incoming RF signals received from the antennae. The front-end system 1203 aids in conditioning signals transmitted to and/or received from the antennae 1204. The antennae 1204 can include antennae used for a wide variety of types of communications. For example, the antennae 1204 can include antennae 1204 for transmitting and/or receiving signals associated with a wide variety of frequencies and communications standards. The baseband system 1201 is coupled to the user interface to facilitate processing of various user input and output, such as voice and data. The baseband system 1201 provides the transceiver 1202 with digital representations of transmit signals, which the transceiver 1202 processes to generate RF signals for transmission. The baseband system 1201 also processes digital representations of received signals provided by the transceiver 1202.

As shown in FIG. 12, the baseband system 1201 is coupled to the memory 1206 to facilitate operation of the wireless device 1200. The memory 1206 can be used for a wide variety of purposes, such as storing data and/or instructions to facilitate the operation of the wireless device 1200 and/or to provide storage of user information. The power management system 1205 provides a number of power management functions of the wireless device 1200. The power management system 1205 receives a battery voltage from the battery 1208. The battery 1208 can be any suitable battery for use in the wireless device, including, for example, a lithium-ion battery. In other cases, however, the battery 1208 may instead be replaced by a mains electricity connection.

Aspects and embodiments of front-end modules as described herein may be incorporated into the wireless device 1200 of FIG. 12, and in particular may be used as the front-end system 1203.

It will be appreciated that the front-end modules described herein, and, for example, used in wireless device 1200, can be arranged in a number of ways for different applications. For example, four 5 GHz front end modules and four 6 GHz front end modules can be used to enable simultaneous transmission and receiving with 4×4 multiple input, MIMO in both the 5 GHz and 6 GHz bands. Alternatively, eight dual band (or higher band) front end modules can be utilized. This can provide a highly flexible 4×4 MIMO design allowing simultaneous transmission and receiving across different bands as determined by the bandpass filters utilized in the dual band front end modules.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general-purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general-purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system comprising:
a transceiver;
a first front-end module (FEM) directly coupled to the transceiver and providing coverage of multiple bands of a wireless network;
a first switch directly coupled to the first front-end module;
a first filter directly coupled to the first switch;
a second filter directly coupled to the first switch;
a second switch directly coupled to the first filter and the second filter; and
a first antenna coupled to the second switch.

2. The system of claim 1 further comprising a host device directly coupled to the transceiver.

3. The system of claim 2 wherein the first FEM provides coverage of a first band and a second band, the system further comprising a second FEM coupled to the host device and providing coverage of the first band.

4. The system of claim 3 further comprising a third FEM coupled to the host device and providing coverage of the second band.

5. The system of claim 3 wherein the first FEM provides partial coverage of the first band and the second FEM provides full coverage of the first band.

6. The system of claim 1 further comprising a diplexer coupled between the second switch and the first antenna.

7. The system of claim 6 wherein the first FEM provides coverage of a first band and a second band, the system further comprising a second FEM coupled to the diplexer and providing coverage of a third band.

8. The system of claim 7 further comprising a third filter coupled between the second FEM and the diplexer.

9. A wireless device comprising:
a first transceiver;
an antenna;
a diplexer coupled between the first transceiver and the antenna;
a first front-end module (FEM) coupled between the first transceiver and the diplexer and providing coverage of a first band and a second band of a wireless network; and
a second FEM coupled to the diplexer and providing coverage of a third band of the wireless network.

10. The wireless device of claim 9 further comprising a host device directly coupled to the first transceiver.

11. The wireless device of claim 10 further comprising a second transceiver coupled between the second FEM and the host device.

12. The wireless device of claim 9 further comprising a first filter coupled between the first FEM and the diplexer and a second filter coupled between the first FEM and the diplexer.

13. The wireless device of claim 12 further comprising a first switch directly coupled to the first filter, the second filter, and the diplexer.

14. The wireless device of claim 12 further comprising a third filter coupled between the second FEM and the diplexer.

15. A wireless device comprising:
a host device;
a first transceiver coupled to the host device;
a second transceiver coupled to the host device;
a first antenna;
a second antenna;
a first front-end module (FEM) coupled between the first transceiver and the first antenna and providing at least partial coverage of a first band and a second band of a wireless network; and
a second FEM coupled between the second transceiver and the second antenna and providing at least partial coverage of the first band of the wireless network.

16. The wireless device of claim 15 further comprising a first filter and a second filter coupled between the first FEM and the first antenna.

17. The wireless device of claim 16 further comprising a first switch directly coupled to the first filter and the second filter.

18. The wireless device of claim 15 further comprising a third FEM coupled to the host device, the third FEM providing at least partial coverage of the second band of the wireless network.

19. The wireless device of claim 18 wherein the third FEM provides full coverage of the second band.

20. The wireless device of claim 15 wherein the second FEM provides full coverage of the first band.
